(19) United States
(12) Patent Application Publication
(10) Pub. No.: US 2015/0235105 A1
(43) Pub. Date: Aug. 20, 2015

(54) APPARATUS AND METHOD FOR RAPIDLY DETECTING OBJECT OF INTEREST

(71) Applicant: Electronics and Telecommunications Research Institute, Daejeon-si (KR)

(72) Inventors: Byung-Gil HAN, Daegu-si (KR); Kil-Taek LIM, Daegu-si (KR); Yun-Su CHUNG, Daegu-si (KR); Soo-In LEE, Daejeon-si (KR)

(73) Assignee: Electronics and Telecommunications Research Institute, Daejeon-si (KR)

(21) Appl. No.: 14/469,635

(22) Filed: Aug. 27, 2014

(30) Foreign Application Priority Data
Feb. 14, 2014 (KR) 10-2014-0017500

(51) Int. Cl. G06K 9/62; G06N 99/00

(52) U.S. Cl. CPC G06K 9/6217; G06N 99/005

(57) ABSTRACT

An apparatus for rapidly detecting an object of interest includes: a first object of interest detector configured to determine a region of an object of interest for an image, from which the object of interest is to be detected, by using a first training image; and a second object of interest detector configured to detect the object of interest from the region of the object of interest determined by the first object of interest detector by using a second training image, which is bigger in size than the first training image.

### CROSS-REFERENCE TO RELATED APPLICATION(S)

This application claims priority from Korean Patent Application No. 10-2014-0017500, filed on Feb. 14, 2014, in the Korean Intellectual Property Office, the entire disclosure of which is incorporated herein by reference for all purposes.

### BACKGROUND

1. Field

The following description relates generally to a technology for rapidly detecting desired objects of interest in video signals, and more particularly to a technology for rapidly detecting regions of objects of interest, such as faces, pedestrians, vehicle license plates, road signs, and the like, which are desired to be detected in input video signals.

2. Description of the Related Art

As security technologies using videos are receiving attention recently, technologies for detecting specific objects of interest, such as faces, pedestrians, vehicle license plates, road signs, and the like, from video signals are attracting attention as well, and research thereon is actively underway. Typical examples of such technologies include a face detection and recognition technology for identifying and verifying individual faces, a pedestrian detection technology for social security, marketing, or the like, a vehicle license plate detection and recognition technology for regulating illegal vehicles and for use in automated and unmanned parking systems, unmanned vehicles, or the like, on which research has been conducted for many years, and which are to be commercialized.

In such a technology for detecting objects of interest, sizes and locations of objects of interest to be detected from input images may not be identified in most cases. Accordingly, the entire image needs to be searched, which requires many calculations, and thus takes much time to detect objects of interest. Particularly, with an increase in resolution of images acquired by an image acquiring device, such as a closed-circuit television (CCTV) or the like, the time required to search an entire image is rapidly increasing.

Conventional technologies currently in use for detecting objects of interest are mostly implemented in high-performance PC systems, as these technologies require many calculations for detecting objects of interest. As there is an increasing need for reducing costs and size of an entire system by embedding detection systems, a higher-speed method of detecting objects of interest is required for an embedded system with lower performance than PC systems.

A most widely used method of detecting objects of interest includes: a process of forming an image group of objects of interest desired to be detected and an image group of objects not of interest as a training set; a process of training that includes representing sample images in the training set using various features, and among the features, selecting features that best distinguish the two groups to implement a detector; and a process of detecting objects of interest by comparing features selected in the training process to input images. A method for representing features includes Haar, local binary pattern (LBP), modified census transform (MCT), center-symmetric local, and the like, and examples of a training method for selecting features that best separate objects from non-objects include Adaboost, a method derived therefrom, and the like.

There are various known feature representation methods and optimal feature training devices. In feature representation methods, a region of an input image, which has the same size as a training image, is represented as features by using the same method as a method used for the training image, and the features of the input image are compared to features of the training image to determine an object of interest. For one pixel after another, the comparison process is repeated for the entire image. A time required for detecting objects of interest may vary depending on a size of a training image, a size of an object of interest desired to be detected, and a time taken for comparing images, which may be represented by the following Equation 1.

S=C×(I_{w}−T_{w})×(Iₕ−Tₕ) [Equation 1]

S: Time for detecting object of interest

C: Time per comparison of image

I_{w}: Width of input image

Iₕ: Height of input image

T_{w}: Width of training image

Tₕ: Height of training image

For example, if a size of a training image is 20×20, and a size of an input image is 640×480, comparison needs to be performed 285,200 times to detect entire images. If a size of an input image is increased twofold to 1280×960, required times of comparison are increased about fourfold to 1,184,400 times. As an identical training image is used, a time taken for one comparison is the same, with a detection time increased about fourfold.

In another example, if a size of an input image is 640×480, and a size of a training image is 10×10, comparison needs to be performed 296,100 times. There are 400 pixels in a training image of 20×20, and there are 100 pixels in a training image of 10×10, which indicate that a 20×20 training image includes four times more information than a 10×10 training image, and takes four times more time for comparing one time, and accordingly, there is a high possibility that it may take less time for detecting an entire object.

In another example, if a size of an input image is 640×480, and a size of an object of interest desired to be detected is 40×40, in a case where detection is performed with a training image of 20×20, an input image size is required to be reduced to 320×240 so as to have a 20×20 object of interest, in which comparison needs to be performed 66,000 times. However, in a case where a 10×10 training image is used, an input image size is reduced to 160×120, such that comparison needs to be performed only about 16,500 times.

As described above, as a size of a training image gets smaller, it takes less time to detect objects of interest. However, smaller training images include less information, and may not have sufficient features for determining objects of interest, thereby increasing a fault detection rate such that objects may be determined as objects of interest, even though the objects are not of interest. Accordingly, there is a limit to reducing a training image size for increasing a detection speed while maintaining sufficient detection performance.

### PRIOR ART DOCUMENT

### Patent Document

Korean Laid-open Patent Publication No. 10-2010-0033923 (published on Mar. 31, 2010)

### SUMMARY

Provided is an apparatus and method for rapidly detecting objects of interest, which overcomes the above limitation while maintaining sufficient performance.

In one general aspect, there is provided an apparatus for rapidly detecting an object of interest, the apparatus including: a first object of interest detector configured to determine a region of an object of interest for an image, from which the object of interest is to be detected, by using a first training image; and a second object of interest detector configured to detect the object of interest from the region of the object of interest determined by the first object of interest detector by using a second training image, in which the first training image is smaller relative to the second training image for a rapid detection of the first object of interest detector, and the second training image is bigger relative to the first training image for an accurate detection of the second object of interest detector.

The apparatus may further include: a first training component configured to train image features to be used by the first object of interest detector to detect the object of interest, and to provide the first training image acquired as a result of the training to the first object of interest detector; and a second training component configured to train image features to be used by the second object of interest to detect the object of interest, and to provide the second training image acquired as a result of the training to the second object of interest detector.

The apparatus may further include a preprocessor configured to preprocess an input image to acquire an image from which an object of interest is to be detected.

The preprocessor may preprocess the input image by using at least one of noise removal, color space conversion, or size conversion.

In another general aspect, there is provided a method for rapidly detecting an object of interest, the method including: determining a region of an object of interest for an image, from which the object of interest is to be detected, by using a first training image; and detecting the object of interest from the region of the object of interest determined by the first object of interest detector by using a second training image, in which the first training image is smaller relative to the second training image for a rapid detection of the first object of interest detector, and the second training image is bigger relative to the first training image for an accurate detection of the second object of interest detector.

The method may further include preprocessing an input image to acquire an image from which an object of interest is to be detected.

The preprocessing may include preprocessing the input image by using at least one of noise removal, color space conversion, and size conversion.

### BRIEF DESCRIPTION OF THE DRAWINGS

FIG. 1 is a block diagram illustrating an example of an apparatus for rapidly detecting objects of interest according to an exemplary embodiment.

FIG. 2 is a flowchart illustrating an example of a method for rapidly detecting objects of interest according to an exemplary embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

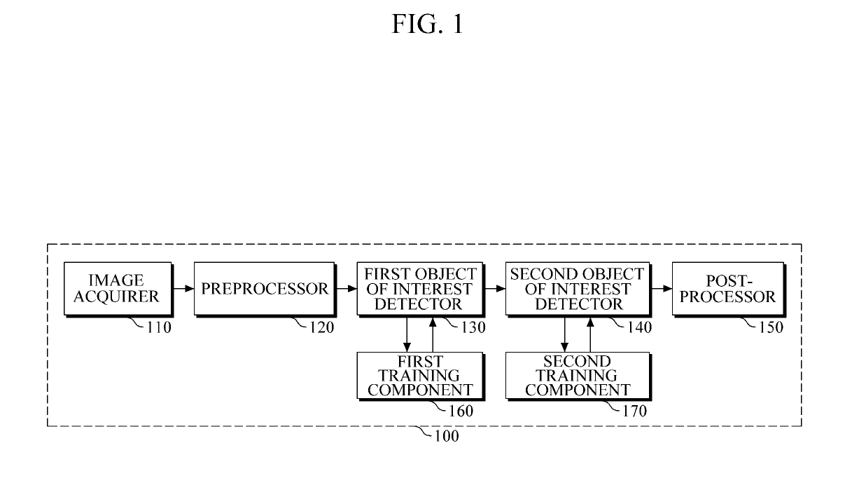

FIG. 1 is a block diagram illustrating an example of an apparatus for rapidly detecting objects of interest according to an exemplary embodiment. The apparatus for rapidly detecting objects of interest may include some of an image acquirer 110, a preprocessor 120, a first object of interest detector 130, a second object of interest detector 140, a post-processor 170, a first training component 160, and a second training component 170, which may be configured in one or more processors 100. The image acquirer 110 acquires an input image from image acquiring devices, such as a camera, a closed-circuit television (CCTV), or the like, and transmits the acquired image to the preprocessor 120. The preprocessor performs preprocessing, such as removing noise, converting color space, converting size, and the like, of the input image to detect an object of interest, and transmits the image, which was obtained by preprocessing, and from which an object of interest is to be detected, to the first object of interest detector 130. The first object of interest detector 130 detects an object of interest from the image, from which an object of interest is to be detected, using a first training image. The first training image is an image of a size appropriate for detection with a high speed but with low accuracy. The first object of interest detector 130 detects an object of interest to determine a region of an object of interest, and transmits an image of the determined region of object of interest to the second object of interest detector 140.

The second object of interest detector 140 detects an object of interest from the region of an object of interest determined by the first object of interest detector 130 by using a second training image. The second training image is an image, which is bigger in size than the first training image, and is appropriate for detection with high accuracy but with a low speed. The second object of interest detector 140 determines an object of interest in the region of an object of interest determined by the first object of interest detector 130, and transmits an image of the determined region of object of interest to the post-processor 170. The post-processor 170 performs post-processing of a region finally determined as an object of interest to be used in practical applications.

In the exemplary embodiment, the first object of interest detector 130 and the second object of interest detector 140 may or may not use an identical method for detecting an object of interest. A different point is that the first object of interest detector 130 uses a detection method with a high speed but with low accuracy to detect an object of interest as rapidly as possible, while the second object of interest detector 140 uses a detection method with high accuracy but with a low speed to finally determine an object of interest by detecting only some regions determined as objects of interest.

The first training component 160 trains image features to be used by the first object of interest detector 130 for detecting an object of interest, and provides a first training image acquired as a result of the training to the first object of interest detector 130. Further, the second training component 170 also trains image features to be used by the second object of interest detector 140 for detecting an object of interest, and provides an image acquired as a result of the training to the second object of interest detector 140. For training image features, the first training component 160 and the second training component 170 may use algorithms, such as scale-invariant feature transform (SIFT), histogram of oriented gradient (HOG), Haar Ferns, local binary pattern (LBP), center-symmetric local binary pattern (CS-LBP), modified census transform (MCT), and the like.

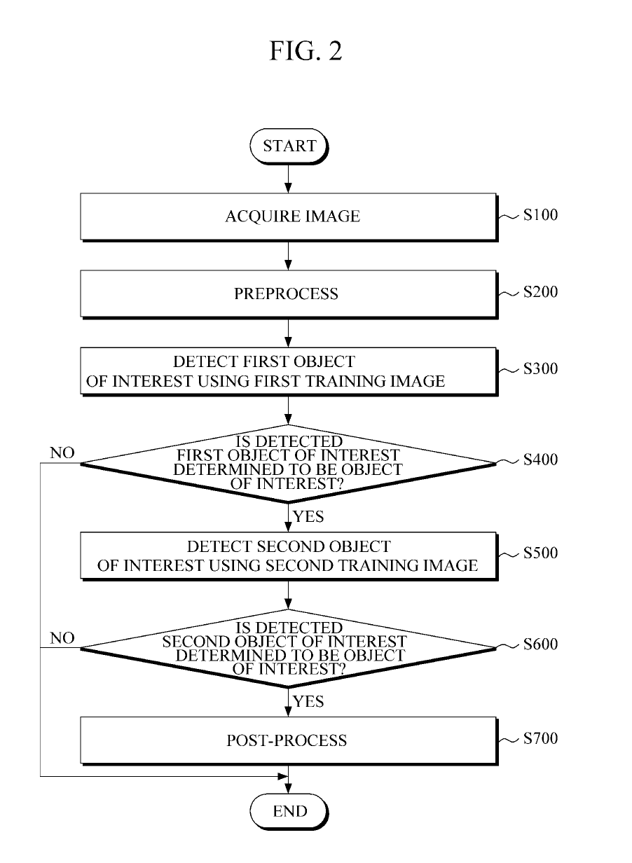

FIG. 2 is a flowchart illustrating an example of a method for rapidly detecting objects of interest according to an exemplary embodiment.

The image acquirer 110 acquires images from a camera, a CCTV, or the like. The preprocessor 120 performs preprocessing, such as removing noise, converting color space, converting size, or the like, in 5200. The first object of interest detector 130 detects a first object of interest using a first training image in 5300. The first object of interest refers to an object of interest detected by the first object of interest detector 130. The first object of interest 130 detects the first object of interest to determine a region of an object of interest in 5400. The second object of interest detector 140 detects a second object of interest from the region determined by the first object of interest detector 130 as an object of interest by using a second training image in 5500. The second object of interest refers to an object of interest detected by the second object of interest detector 140 with respect only to the first object of interest. The second object of interest detector 140 detects a second object of interest to determine a region of an object of interest in 5600. Once the second object of interest detector 150 determines a region of an object of interest, the post-processor 170 performs post-processing of the determined region of object of interest in 5700 to be used in practical applications.

As described above, if a size of an input image is 640×480, and a size of an object of interest desired to be detected is 40×40, in a case where the first object of interest detector 130 uses a training image of 10×10 with a fault detection rate of 50%, and the second object of interest detector 140 uses a training image of 20×20 with a fault detection rate of 1%, the first object of interest detector 130 may search an entire image by only comparing regions 16,500 times, among which 8,250 regions are statistically determined as objects of interest, and are transmitted to the second object of interest detector 140. The object of interest detector 140 is not required to compare 66,000 times, but to compare only the 8,250 regions determined as objects of interest by the first object of interest detector 130. As a result, by comparing only 24,725 times in total, an object of interest may be detected with a fault detection rate of 1%. Such difference gets bigger as resolution of an input image becomes higher, and a fault detection rate of the first object of interest detector 130 becomes lower.

In the apparatus and method for rapidly detecting objects of interest, by using a training image with a focus on speed, and a training image with a focus on accuracy, objects of interest may be detected with a higher speed while maintaining accuracy and advantages of a conventional method. Specifically, the technology for rapidly detecting objects of interest may be used properly in an embedded system with relatively lower performance than a PC system.

The methods and/or operations described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for rapidly detecting an object of interest, the apparatus comprising:
a first object of interest detector configured to determine a region of an object of interest for an image, from which the object of interest is to be detected, by using a first training image; and
a second object of interest detector configured to detect the object of interest from the region of the object of interest determined by the first object of interest detector by using a second training image,
wherein the first training image is smaller relative to the second training image for a rapid detection of the first object of interest detector, and the second training image is bigger relative to the first training image for an accurate detection of the second object of interest detector.

2. The apparatus of claim 1, further comprising:
a first training component configured to train image features to be used by the first object of interest detector to detect the object of interest, and to provide the first training image acquired as a result of the training to the first object of interest detector; and
a second training component configured to train image features to be used by the second object of interest to detect the object of interest, and to provide the second training image acquired as a result of the training to the second object of interest detector.

3. The apparatus of claim 1, further comprising a preprocessor configured to preprocess an input image to acquire an image from which an object of interest is to be detected.

4. The apparatus of claim 3, wherein the preprocessor preprocesses the input image by using at least one of noise removal, color space conversion, and size conversion.

5. A method for rapidly detecting an object of interest, the method comprising:
determining a region of an object of interest for an image, from which the object of interest is to be detected, by using a first training image; and
detecting the object of interest from the region of the object of interest determined by the first object of interest detector by using a second training image,
wherein the first training image is smaller relative to the second training image for a rapid detection of the first object of interest detector, and the second training image is bigger relative to the first training image for an accurate detection of the second object of interest detector.

6. The method of claim 5, further comprising preprocessing an input image to acquire an image from which an object of interest is to be detected.

7. The method of claim 6, wherein the preprocessing includes preprocessing the input image by using at least one of noise removal, color space conversion, and size conversion.
